(19) United States
(12) Patent Application Publication
(10) Pub. No.: US 2009/0063712 A1
(43) Pub. Date: Mar. 5, 2009

(54) KVM SWITCH IDENTIFYING PERIPHERAL FOR COMPUTER AND METHOD THEREOF

(75) Inventors: Shou-chih Sun, Shijr City (TW); Pai-Yi Hsieh, Shijr City (TW)

Correspondence Address: AUSTIN RAPP & HARDMAN, 15 WEST SOUTH TEMPLE, SUITE 900, SALT LAKE CITY, UT, 84101, US

(73) Assignee: Aten International Co., Ltd., Shijr City (TW)

(21) Appl. No.: 11/850,333

(22) Filed: Sep. 5, 2007

(51) Int. Cl. G06F 3/02

(52) U.S. Cl. 710/4

(57) ABSTRACT

Disclosed is a KVM switch identifying a peripheral for at least one computer coupled thereto. The KVM switch comprises a memory and a KVM control module. The memory stores identification data responded by the peripheral while the peripheral is being initialized by the KVM switch and stores an initializing command generated by the computer when the computer requests the identification data. The KVM control module sends the initializing command stored in the memory to the peripheral to request the identification data when the peripheral is connected to the KVM switch and replies to the computer with the identification data stored in the memory when the computer requests the identification data for identifying the peripheral. The KVM control module also updates the initializing command stored in the memory if a new initializing command is generated by the computer.

### FIELD OF THE INVENTION

The present invention generally relates to a KVM switch, and more particularly to a KVM switch capable of identifying a peripheral for computers coupled thereto and method thereof.

### BACKGROUND OF THE INVENTION

In a personal computer system, a peripheral such as, a keyboard, a mouse or a printer is connected with the computer directly. Generally, the computer which has an installed driver corresponding to the peripheral will request identification data of such peripheral during the computer powering-up period or when the peripheral is connected to the computer. The purpose of requesting the identification data by the computer is to identify the peripheral so that the peripheral can work normally with the computer.

Especially for some peripheral having a special capability, for example, a keyboard with a multimedia function, aforesaid identifying procedure is necessary to a computer coupled with. After the identifying procedure is done, then the special capability of the peripheral can be functional. In a KVM switch system, a peripheral is connected to a plurality of computers via a KVM switch, and a user may access to one of the computers via a console at the KVM switch. However, the computer cannot identify the peripheral because the KVM switch only simulates virtual peripherals according to standard or basic protocols. According to prior art, peripherals having special capabilities, such as, a multimedia keyboard or a multimedia mouse, are identified as standard devices in a KVM switch system. Therefore, those special capabilities are ignored.

Consequently, a KVM switch capable of identifying a peripheral for the computer coupled thereto becomes necessary to solve aforesaid drawbacks of prior art and thus meets requirement for lots of peripheral having a special capability in modern time.

### SUMMARY OF THE INVENTION

To solve the foregoing drawbacks in the prior art, it is an objective of the present invention to provide a KVM switch capable of identifying a peripheral for at least one computer coupled thereto and method thereof. Therefore, special capabilities of the peripheral can be executed on the computer.

The KVM switch of the present invention comprises a memory and a KVM control module. The memory stores identification data of the peripheral when the peripheral is connected to the KVM switch and stores an initializing command generated by the computer when the computer requests the identification data. Thereafter, the KVM control module sends the initializing command stored in the memory to the peripheral to request the identification data while the peripheral is being initialized by the KVM switch, and replies to the computer with the identification data stored in the memory when the computer requests the identification data for identifying the peripheral. The KVM control module also updates the initializing command stored in the memory if a new initializing command is generated by the computer.

The present invention further provides a method of identifying a peripheral for at least one computer coupled to a KVM switch. The method comprises steps described below:

storing an initializing command generated by the computer when the computer requests identification data for identifying the peripheral;

sending the initializing command stored in a memory to the peripheral to request the identification data while the peripheral is being initialized by the KVM switch;

storing identification data of the peripheral while the peripheral is being initialized by the KVM switch; and

replying to the computer with the identification data stored in a memory when the computer requests the identification data for identifying the peripheral.

The method of the present invention further comprises a step of updating the initializing command stored in the memory if a new initializing command is generated by the computer.

Specifically, after the initializing command of the computer and the identification data of the peripheral have been stored in the memory, there will be no particular sequence for implementing the steps in the method of the present invention. A dual process to the peripheral and to the computer as aforementioned at the same time can be common for the KVM switch to identify the peripheral for the computer to realize executing the special capabilities of the peripheral on the computer by a user at a console of the KVM switch.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a simplified block diagram of a KVM switch capable of identifying a peripheral for computers coupled thereto according to the present invention; and

FIG. 2 illustrates a flowchart of a method of identifying a peripheral for computers coupled to a KVM switch according to the present invention.

### DETAILED DESCRIPTION OF THE INVENTION

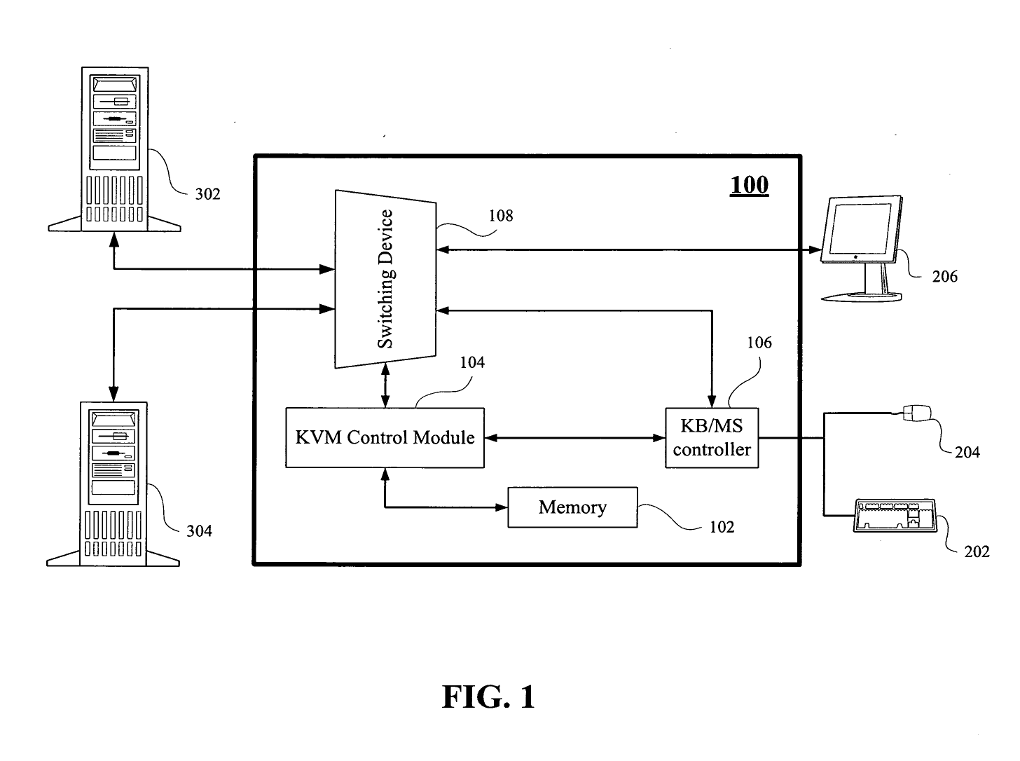

Please refer to FIG. 1, which illustrates a simplified block diagram of a KVM switch 100 capable of identifying a peripheral for computers 302, 304 coupled thereto according to the present invention. The peripheral in this example may be a keyboard 202 or a mouse 204 but is not a limitation to the present invention. The KVM switch 100 comprises a memory 102, a KVM control module 104, a KB/MS controller (keyboard/mouse controller) 106 and a switching device 108. The KB/MS controller (keyboard/mouse controller) 106 detects and transforms the operation of the keyboard 202 and the mouse 204 into KB/MS operation data. The switching device 108 routes the KB/MS operation data and video data between a keyboard 202, a cursor controller (a mouse) 204, display 206 of a console and the computers 302, 304 respectively.

In this example, a driver corresponding to the peripheral (the keyboard 202 or the mouse 204) is either bundled in the operation system, or needs to be installed in the computers 302, 304. During the computer's 302 powering up period (same for the computer 304), the driver of the peripheral generates an initializing command to the KVM switch 100 to request identification data for identifying the peripheral. The memory 102 of the KVM switch 100 in the present invention stores the initializing command. Next, the KVM control module 104 sends the initializing command stored in the memory 102 to the peripheral to request the identification data, and thus to initialize the peripheral. If the peripheral is already connected to the KVM switch 100, the peripheral will responds to the KVM control module 104 with the identification data for identifying itself. If the peripheral is connected to the KVM switch 100 afterward, then the KVM control module 104 sends the initializing command stored in the memory 102 while the peripheral is connected to and being initialized by the KVM switch 100.

Then, the memory 102 stores the identification data of the peripheral and the KVM control module 104 replies to the computer with the identification data stored in the memory 102. Thereafter, the KVM control module 104 updates the initializing command stored in the memory 102 if a new initializing command is generated by the computer 302. This may be required under a certain scenario, for example, a newer version of the driver corresponding to the peripheral (the keyboard 202 or the mouse 204) has been installed in the computer 302. Furthermore, the memory 102 may also store a default initializing command and a default identification data for identifying the peripheral as a standard device (a standard keyboard or a standard mouse) to ensure that the peripheral can work normally with the computer via the KVM switch 100. That is, if the driver installed in the computer 302 does not correspond to the peripheral (the keyboard 202 or the mouse 204), the initializing command generated by the driver cannot identify the peripheral, the KVM control module 104 sends the default initializing command to the peripheral for identifying or replies to the computer 302 with the default identification data instead.

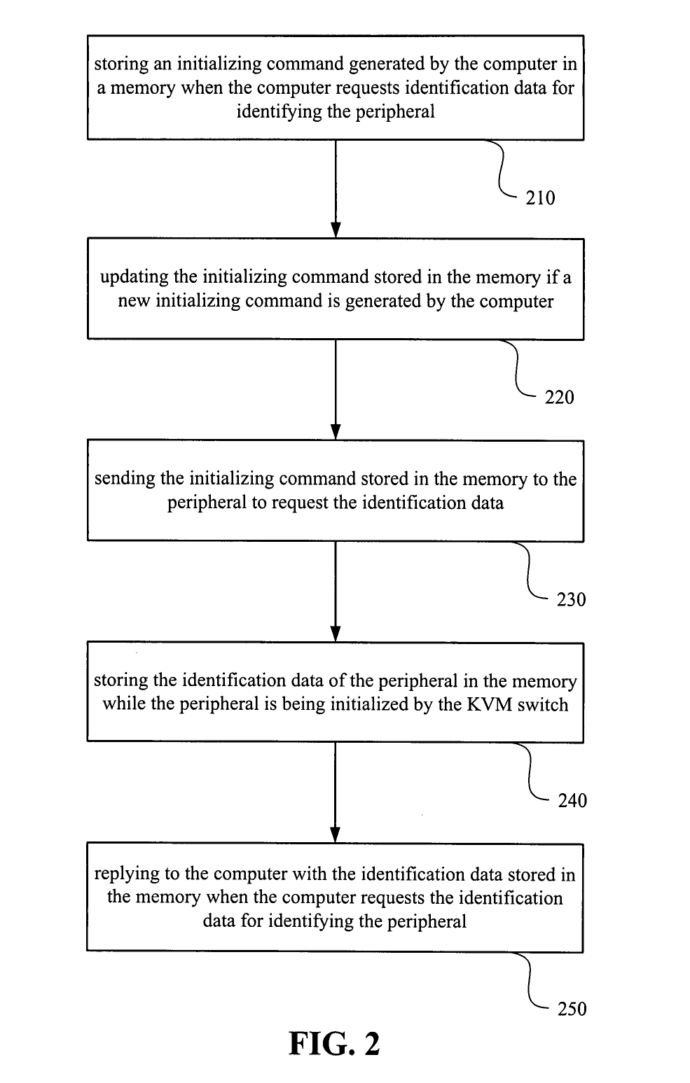

Please refer to FIG. 2, which illustrates a flowchart of a method of identifying a peripheral for computers coupled to a KVM switch to accomplish the objective of the present invention. The method comprises the following steps:

Step 210, storing an initializing command generated by the computer when the computer requests identification data for identifying the peripheral;

Step 220, updating the initializing command stored in the memory if a new initializing command is generated by the computer;

Step 230, sending the initializing command stored in the memory to the peripheral to request the identification data;

Step 240, storing identification data of the peripheral while the peripheral is being initialized by the KVM switch; and

Step 250, replying to the computer with the identification data stored in the memory when the computer requests the identification data for identifying the peripheral.

Specifically, once a KVM switch completes aforesaid steps to store the initializing command and the identification data in the memory, there is no particular sequence for implementing the aforesaid steps.

Thereafter, the step 210 and the step 250 can be executed at the computer side. The memory stores the initializing command generated by the computer and the KVM control module replies the identification data stored in the memory to the computer when the computer is powered up to request the identification data for identifying the peripheral each time.

Thereafter, the step 230 and the step 240 can be executed at the peripheral side. The KVM control module sends the initializing command stored in the memory to the peripheral to request the identification data while the peripheral is plugged to connect with the KVM switch each time. Meanwhile, the memory stores the identification data of the peripheral.

Moreover, if a new initializing command is generated by the computer, such as a newer version driver is installed in the computer, the steps 210, 220, 230, 240 and 250 can be executed all in aforesaid order to complete a preparation for requesting the identification data to identify the peripheral for the computer correctly.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A KVM switch identifying a peripheral for at least one computer coupled thereto, the KVM switch comprising:
a memory, storing identification data responded by the peripheral while the peripheral is being initialized by the KVM switch; and
a KVM control module, replying to the computer with the identification data stored in the memory when the computer requests the identification data for identifying the peripheral.

2. The KVM switch of claim 1, wherein the memory stores an initializing command which is generated by the computer when the computer requests the identification data.

3. The KVM switch of claim 2, wherein KVM control module sends the initializing command stored in the memory to the peripheral to request the identification data.

4. The KVM switch of claim 2, wherein the KVM control module updates the initializing command stored in the memory if a new initializing command is generated by the computer.

5. The KVM switch of claim 1, wherein the memory further has a default identification data stored therein.

6. The KVM switch of claim 2, wherein the memory further has a default initializing command for identifying the peripheral stored therein.

7. The KVM switch of claim 1, wherein the peripheral is a keyboard.

8. The KVM switch of claim 1, wherein the peripheral is a cursor controller.

9. A KVM switch identifying a peripheral for at least one computer coupled thereto, the KVM switch comprising:
a memory, storing an initializing command generated by the computer when the computer requests identification data for identifying the peripheral; and
a KVM control module, sending the initializing command stored in the memory to the peripheral to request the identification data while the peripheral is being initialized by the KVM switch.

10. The KVM switch of claim 9, wherein the KVM control module updates the initializing command stored in the memory if a new initializing command is generated by the computer.

11. The KVM switch of claim 9, wherein the memory stores the identification data of the peripheral when the peripheral is connected to the KVM switch.

12. The KVM switch of claim 11, wherein the KVM control module replies to the computer with the identification data stored in the memory when the computer requests the identification data for identifying the peripheral.

13. The KVM switch of claim 9, wherein the memory further has a default initializing command for identifying the peripheral stored therein.

14. The KVM switch of claim 10, wherein the memory further has a default identification data stored therein.

15. The KVM switch of claim 9, wherein the peripheral is a keyboard.

16. The KVM switch of claim 9, wherein the peripheral is a cursor controller.

17. A method of identifying a peripheral for at least one computer coupled to a KVM switch, the method comprising steps of:
storing identification data responded by the peripheral while the peripheral is being initialized by the KVM switch; and
replying to the computer with the identification data stored in a memory when the computer requests the identification data for identifying the peripheral.

18. The method of claim 17, further comprising a step of storing an initializing command generated by the computer in the memory when the computer requests identification data for identifying the peripheral.

19. The method of claim 18, further comprising a step of sending the initializing command stored in the memory to the peripheral to request the identification data.

20. The method of claim 18, further comprising a step of updating the initializing command stored in the memory if a new initializing command is generated by the computer.

21. A method of identifying a peripheral for at least one computer coupled to a KVM switch, the method comprising steps of:
storing an initializing command generated by the computer when the computer requests identification data for identifying the peripheral; and
sending the initializing command stored in a memory to the peripheral to request the identification data while the peripheral is being initialized by the KVM switch.

22. The method of claim 21, further comprising a step of updating the initializing command stored in the memory if a new initializing command is generated by the computer.

23. The method of claim 21, further comprising a step of storing the identification data responded by the peripheral in the memory while the peripheral is being initialized by the KVM switch.

24. The method of claim 23, further comprising a step of replying to the computer with the identification data stored in the memory when the computer requests the identification data for identifying the peripheral.
